(19) United States
(12) Patent Application Publication
(10) Pub. No.: US 2003/0005168 A1
(43) Pub. Date: Jan. 2, 2003

(54) System and method for auditing system call events with system call wrappers

(76) Inventors: Scott Alan Leerssen, Atlanta, GA (US); Joubert Berger, Atlanta, GA (US)

Correspondence Address: HEWLETT-PACKARD COMPANY, Intellectual Property Administration, P.O. Box 272400, Fort Collins, CO, 80527-2400, US

(21) Appl. No.: 09/896,242

(22) Filed: Jun. 29, 2001

(51) Int. Cl. G06F 15/163; G06F 9/54; G06F 9/00; G06F 9/46

(52) U.S. Cl. 709/313; 709/310

(57) ABSTRACT

In one embodiment, the present invention is directed to a system and method in which a wrapper function is placed in memory. Additionally, address information is written into an entry of a system call table, said address information being associated with said wrapper function. Further, processing control is transferred to said wrapper function. The wrapper function transfers processing control to a system call routine, retrieves parameters associated with the system call routine, utilizes the parameters to generate audit data, and writes the audit data to a buffer.

### RELATED APPLICATION

This application is related to concurrently filed and commonly assigned U.S. patent application Ser. No. ______, enttitled “SYSTEM AND METHOD FOR TRANSFORMING OPERATING SYSTEM AUDIT DATA TO A DESIRED FORMAT,” which is hereby incorporated herein by reference.

### TECHNICAL FIELD

The present invention is directed generally to operating systems, and more particularly to a system and method for generating audit data associated with system call operations.

### BACKGROUND OF THE INVENTION

An Operating System (OS) is arguably the most important program executing on a computer system, because the OS is utilized in executing all other programs (which are commonly referred to as “applications”). In general, the OS provides functionality that applications may then utilize. For instance, an application may invoke an OS routine (e.g., via a system call) to save a particular file, and the OS may interact with the basic input/output system (BIOS), dynamic link libraries, drivers, and/or other components of the computer system to properly save the particular file. Many different OSs have been developed in the prior art, including HP-UX®), Linux™, MS-DOS®, OS/2®, Windows®, UniX™, System 8, and MPE/iX, as examples.

FIG. 1 shows an exemplary system 100, which includes an OS 101. As shown, OS 101 may perform such tasks as recognizing input from keyboard 106 and mouse 104, sending output to display screen 107, and controlling peripheral devices, such as disk drive 103 and printer 105. Some OSs have integrated therein relatively complex functions that were once performed only by separate programs, such as faxing, word processing, disk compression, and Internet browsers. Generally, OSs provide a software platform on top of which other programs, such as application 102, may execute. Application programs are generally written to execute on top of a particular OS, and therefore, the particular OS implemented on a computer system may dictate, to a large extent, the types of applications that can be executed on such computer system.

Application 102 executing on computer system 100 may rely on operating system routines to perform such basic tasks as recognizing input from keyboard 106 and mouse 104, as well as sending output to display screen 107, as examples. OS 101 comprises sets of routines for performing various tasks (e.g., low-level operations). For example, operating systems commonly include routines for performing such tasks as creating a directory, opening a file, closing a file, and saving a file, as examples. Application 102 may invoke certain operating system routines to perform desired tasks by making a system call. That is, applications generally invoke operating system routines via system calls. Also, a user may interact with OS 101 through a set of commands. For example, the DOS operating system contains commands such as COPY and RENAME for copying files and changing the names of files, respectively. The commands are accepted and executed by a part of the OS called the command processor or command line interpreter. Additionally, a graphical user interface may be provided to enable a user to enter commands by pointing and clicking objects appearing on the display screen, for example.

The central module of an operating system is the kernel. Typically, the kernel is responsible for memory management, process and task management, and disk management. Applications access the kernel through system call operations or “syscalls.” A system call is typically considered a request to the operating system (kernel) to do a hardware/system-specific or privileged operation. Examples of system calls include fork, pipe, read, waitpid, write, and execve. In the Linux operating system, for example, the system calls are included in the “unistd.h file”. The system calls are also included in the “libc” as stubs, where a system call identifier is defined via the “#define” command to be equal to a certain number or vector to facilitate access to the particular desired routines of the kernel.

To allow access to the system calls, an interrupt instruction is typically utilized. Specifically, an application pushes various arguments onto its stack and then executes the appropriate interrupt instruction. The CPU in response to the interrupt instruction transfers control to the kernel entry point which is _system_call( ) in the Linux operating system. The kernel entry point performs various tasks such as saving all registers and verifying that a valid system call was invoked. Most importantly, the kernel entry point utilizes the vector to obtain a memory offset address from the syscall table to determine the location of the particular kernel system call routine. The kernel entry point then transfers control to the routine located at the particular memory location.

Additionally, kernel system call routines commonly audit system calls from applications. For example, suppose an application makes a system call to open a particular file, audit code within the respective kernel system call routine may collect such audit data for the system call as the date and time the system call was made, name of file to be opened, and result of system call (e.g., system file opened successfully or failed). Trusted OSs, including without limitation Hewlett-Packard CMW (compartment mode workstation), Hewlett-Packard VirtualVault, Sun Trusted Solaris, and SCO CMW, commonly perform auditing of at least security relevant events.

FIG. 2 depicts exemplary interaction between an application and the kernel according to the prior art. In system 200, program 201 is operating in user space, i.e., a system mode that includes certain hardware limitations that prevent program 201 from interfering with other processes. Program 201 includes various code including the file open operation: “fd=open(“FOO”, RD_ONLY). This file operation includes a system call to “open.” The system call pushes information onto the stack and executes the appropriate interrupt instruction. The CPU of system 200 causes control to be transferred to the kernel entry point. The kernel entry point examines syscall table 202 to determine the memory location associated with the “open” routine. The kernel entry point then transfers control to kernel system call routine 203 which performs the “open” operations.

In addition, the kernel typically has been utilized to perform security-related tasks. For example, kernel system call routines include auditing code to allow audit administrators to track the activities of users and applications. For example, the kernel “open” system call routine may include code that writes the user_id, application_id, time, date, and filename for each open operation to be written to an audit file. A system administrator may examine the audit file to determine whether a particular user or a particular application is attempting to obtain access to permission-limited files. For example, a hacker may attempt to read a password file. The audit information may alert the system administrator that a hacker is attempting to breach the security of the system.

However, this approach is problematic for many reasons. In particular, the approach of placing audit code within the particular system call routines of the kernel greatly increases the difficulty of changing the audit functionality to suit a particular system. Specifically, any changes in the audit code requires the operating system to be recompiled and reinstalled. Additionally, porting is required for each released version of the operating system. Moreover, audit code is generally indiscriminate in that it reports substantial numbers of audit records despite the relevance to a particular system. Gigabytes of audit information may be produced with very little information having any importance to security issues.

### SUMMARY OF THE INVENTION

According to at least one embodiment of the present invention, a computer readable medium is disclosed that includes instructions executable by a processor-based system, wherein the computer readable medium comprises code for replacing address information in a system call table with address information associated with a plurality of wrapper functions. Further, the computer readable medium comprises code for defining the plurality of wrapper functions, such plurality of wrappers functions transferring processing control to system call routines, such plurality of wrapper functions retrieving parameters associated with the system call routines, such plurality of wrapper functions utilizing the parameters to generate audit data, and such plurality of wrapper functions writing the audit data to a buffer.

According to at least one embodiment of the present invention, a method for generating audit data is disclosed, which comprises placing a wrapper function in memory, and writing address information into an entry of a system call table, such address information being associated with the wrapper function. The method further comprises transferring processing control to the wrapper function, such wrapper function transferring processing control to a system call routine, retrieving parameters associated with the system call routine, utilizing the parameters to generate audit data, and writing the audit data to a buffer.

According to at least one embodiment of the present invention, a computer system for generating audit data associated with system calls is disclosed. Such computer system comprises means for receiving processing control, such means for receiving being operable to transfer processing control to a system call routine and being operable to generate audit data associated with the system call routine. The computer system further comprises means for transferring control to the means for receiving, wherein such means for transferring control includes a system call table with address information associated with such means for receiving processing control.

### BRIEF DESCRIPTION OF THE DRAWINGS

FIG. 1 depicts an exemplary computer system including an operating system according to the prior art.

FIG. 2 is a flowchart depicting interaction between a user application and the kernel according to the prior art.

FIG. 3 depicts an exemplary configuration of prior art systems for generating operating system audit data.

FIG. 4 is a flowchart depicting interaction between a user application, a wrapper function, and the kernel according to embodiments of the present invention.

FIG. 5 depicts a block diagram of an exemplary computer system adapted according to embodiments of the present invention.

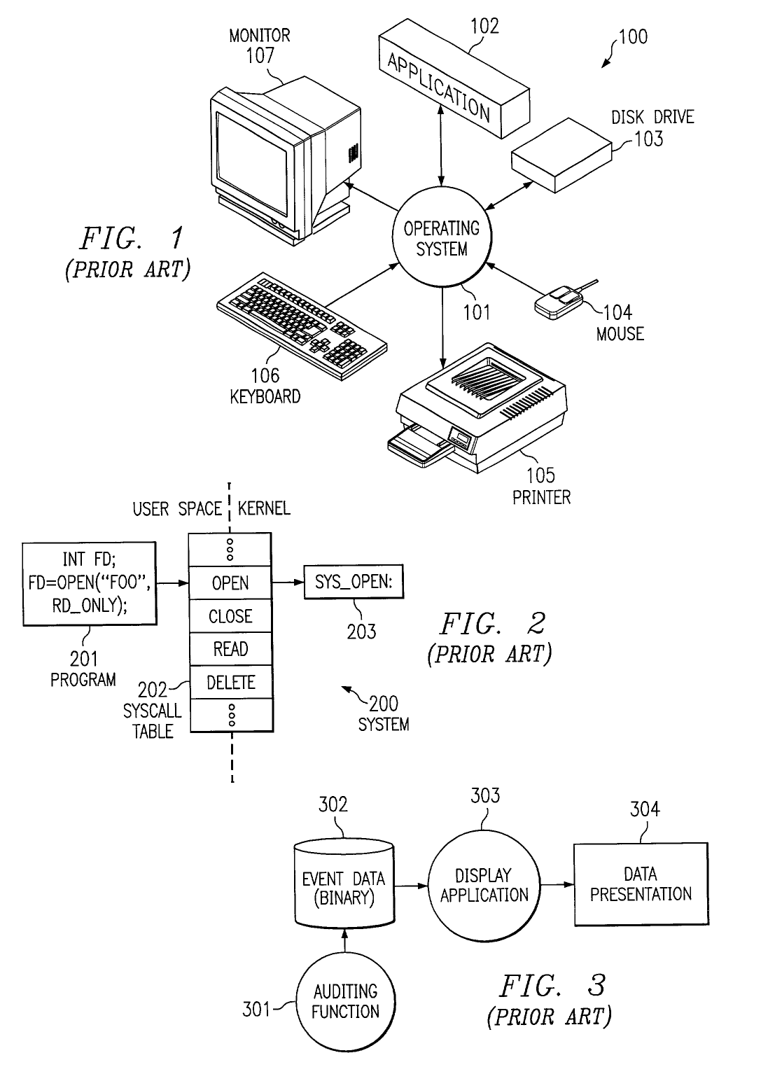

### DETAILED DESCRIPTION

The present invention is directed to a system and method for allowing addition, removal, or modification of audit code without requiring the system call routines of the operating system kernel to be rebuilt. In embodiments of the present invention, a copy of the original syscall table is placed elsewhere in memory after the normal system start-up operations. Address information associated with wrapper functions is inserted into the syscall table. The wrapper functions are interposition code between a calling process and code that actually performs the task desired by the calling process. When an application performs a system call, the respective wrapper function is first called, because its address is contained in the syscall table. It shall be appreciated that causing the system call to be directed first to the respective wrapper function is advantageous. Specifically, the audit code may be placed into the wrapper function instead of being placed in the various kernel system call routines. By separating the audit code from the kernel system call routines, modification of the audit code does not effect the kernel system call routines. This allows system administrators to modify the audit code without appreciable difficulty. Accordingly, audit code is not arbitrarily restricted by the developers of the operating system. Instead, audit code may be developed on a case by case basis by system administrators to be adapted to their particular systems.

After the wrapper function is called, the wrapper function then locates the address for the appropriate kernel system call routine in the copy of the original syscall table. The wrapper function then transfers control to the appropriate kernel system call routine which executes the desired task. When the kernel system call routine returns the result parameters, the wrapper function examines the parameters. The wrapper function then performs any desired audit operations such as writing to an audit file or audit buffer. The wrapper function completes the system call by returning the parameters to the application that performed the system call.

A typical configuration of prior art systems for generating OS audit data is shown in FIG. 3. As shown, auditing program 301 is executing on a system, which is operable to audit the execution of routines (which may be referred to as “events”). For instance, auditing program 301 may execute in the kernel of an OS to collect audit data regarding use of an operating system routine that is invoked via a system call (or “syscall”) made by an application. For example, as mentioned earlier, suppose an application makes a system call to open a particular file, audit program 301 within the OS may collect such audit data for the system call as the date and time the system call was made, name of file to be opened, and result of system call (e.g., system file opened successfully or failed).

In certain implementations, auditing program 301 may audit only security events, but in other implementations it may provide additional auditing (e.g., may include application and system level logging). According to at least one implementation, auditing program 301 may comprise an audit device driver that collects audit data. Additionally, auditing program 301 may comprise an interface (e.g., API) from the kernel to user-space applications, which may enable event data to be passed to such user-space applications (e.g., an audit collection daemon) and/or may enable event data to be received at the kernel from user-space applications and/or users (e.g., system administrators).

Auditing program 301 stores the audit data (which may be referred to as “event data”) to data storage 302. Data storage 302 generally comprises a disk drive. According to at least one implementation, collected audit data may be buffered within the kernel of the OS, and as such buffer begins filling, the kernel notifies an audit collection daemon, which is a process (that may be executing in the user space of the OS) that collects the audit data from the kernel and writes it to data storage 302. Typically, collected audit data is stored in binary format within data storage 302. Audit data collected for a particular event (e.g., particular invocation of an OS routine) is generally referred to as a record. Thus, data storage 302 may include many records, wherein each record includes audit data for a particular event.

Display application 303 is typically provided by the provider of the OS that includes auditing program 301. Display application 303 is typically a user-space application that is executable to retrieve collected audit data from data storage 302 and present the data to a user on a display 304 (e.g., computer monitor). A user, such as a system administrator, may view the collected audit data to, for example, trouble-shoot a problem being encountered with the computer system or evaluate the system's security.

Exemplary implementations for collecting and displaying audit data in a more flexible manner are disclosed in concurrently filed and commonly assigned U.S. patent application Ser. No. ______, entitled “SYSTEM AND METHOD FOR TRANSFORMING OPERATING SYSTEM AUDIT DATA TO A DESIRED FORMAT,” which has been incorporated herein by reference.

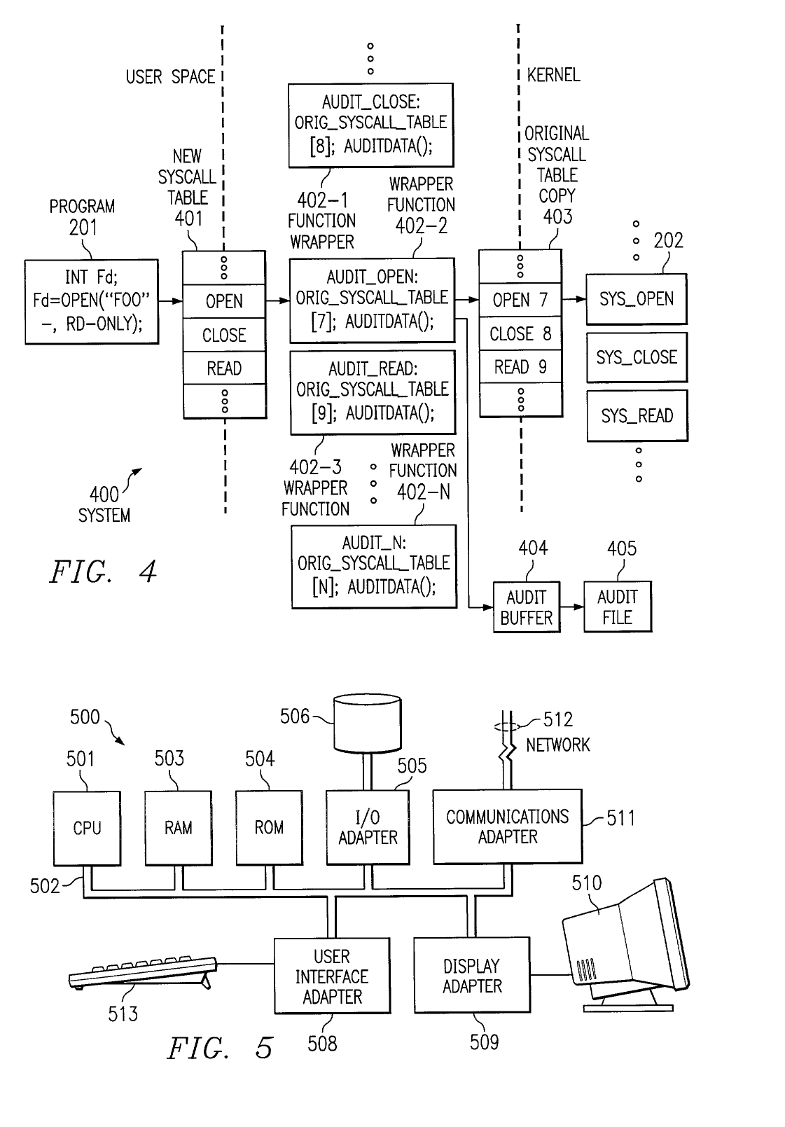

FIG. 4 depicts exemplary interaction between application 201, wrapper function 402-2, and the kernel according to an embodiment of the present invention. In accordance with this embodiment of the present invention, ordinary start-up procedures are followed. The start-up operations write the offset addresses of kernel system call routines into the syscall table. However, according to the teachings of the present invention, the original syscall table is copied to a new memory location which is preferably designated as original syscall table copy 403. In the memory location previously occupied by the original syscall table, new syscall table 401 is created. New syscall table 401 contains memory offsets to wrapper functions 402-1 through 402-N.

In system 400, program 201 is operating in user space. Program 201 includes various code including the file open operation: “fd=open(“FOO”, RD_ONLY). This file operation includes a system call to “open.” The system call pushes information onto the stack and executes the appropriate interrupt instruction. The CPU of system 400 causes control to be transferred to the kernel entry point. The kernel entry point examines new syscall table 401 to determine the memory location associated with the “open” routine. Since new syscall table 401 contains the offset address to wrapper function 402-2, the kernel entry point transfers control to wrapper function 402-2.

Wrapper function 402-2 contains the audit code that is performed when the system call “open” is called, Wrapper function 402-2 utilizes original syscall table copy 403 to determine the memory location of the appropriate kernel system call routine associated with the “open” operations, which is kernel system call routine 202. For example, wrapper function 402-2 may utilize the vector associated with the system call to determine the memory location of kernel system call routine 202. In this example, the open system call is associated with the vector value 7. Wrapper function 402-2 utilizes the vector value to determine the memory location of kernel system call routine 202. Wrapper function 402-2 passes control to kernel system call routine 202 utilizing the memory location. Kernel system call routine 202 performs the “open” operations.

Control is then returned to wrapper function 402-2. Wrapper function 4022 examines arguments associated with kernel system call routine 202. Wrapper function 402-2 may utilize various arguments to determine whether any auditing steps are appropriate. It may be desirable to not perform any auditing steps for opening a file that possesses little security concerns. If auditing steps are desired, wrapper function 402-2 writes the appropriate audit data to audit buffer 404. For example, wrapper function 402-2 may include code that writes the user_id, application_id, time, date, and filename for each open operation to be written to audit buffer 404. It is advantageous to write audit data to audit buffer 404 to reduce the impact of auditing on system performance. A buffer daemon may monitor audit buffer 404. When the amount of buffered audit data exceeds some predetermined amount, the buffered audit data may be written to audit file 405. By doing so, the number of file operations may be minimized so as to reduce the performance degradation of user applications. After audit data has been written to audit buffer 404, wrapper function 402-2 then signals to the CPU that the interrupt has been completed by executing the appropriate instruction. The CPU of system 400 returns control to program 201.

In a similar manner, program 201 may perform system calls to other wrapper functions. Program 201 may perform a system call to wrapper function 402-1 to close a file or may perform a system call to wrapper function 402-3 to read from a file. Wrapper functions 402-1 and 402-3 receive processing control transfer via CPU interrupt operations as discussed above. Wrapper functions 402-1 and 402-3 transfer control to the appropriate kernel system call routines by utilizing original syscall table copy 403. Wrapper functions 402-1 and 402-3 then perform auditing operations as defined by their audit code. Wrapper functions 402-1 and 402-3 may examine parameters associated with the system calls (e.g., user_id, application_id, time, date, and filename). Wrapper functions 401-1 and 402-3 may generate audit data from the parameters. Wrapper functions 401-1 and 402-3 write the audit data to audit buffer 404. It shall be appreciated that auditing is not limited to file operations. Auditing data may be generated for any type of system call. Auditing data may be generated for systems calls related to thread handling, inter-process communication, or user-id (UID) handling, as examples.

When implemented via executable instructions, various elements of the embodiments of the present invention comprise the code defining the operations of such various elements. The executable instructions or code may be obtained from a readable medium (e.g., a hard drive media, optical media, EPROM, EEPROM, tape media, cartridge media, flash memory, ROM, and/or the like) or communicated via a data signal from a communication medium (e.g., the Internet). As used herein, readable media is intended to include any medium that may store or transfer information.

FIG. 5 depicts exemplary computer system 500 on which embodiments of the present invention may be implemented. Central processing unit (CPU) 501 is coupled to system bus 502. CPU 501 may be any general purpose CPU. Suitable processors, without limitation, include any processor from the Itanium™ family of processors, such as the McKinley processor, available from Hewlett-Packard Company, or an PA-8500 processor also available from Hewlett-Packard Company. CPU 501 advantageously supports software interrupts to allow kernel access according to embodiments of the present invention. However, the present invention is not restricted by the architecture of CPU 501 as long as CPU 501 supports the inventive operations as described herein. Additionally, it shall be appreciated that the present invention is not limited to single processor platforms. For example, the auditing features of embodiments of the present invention may be advantageously adapted to multi-processor systems. Computer system 500 includes random access memory (RAM) 503, which may be SRAM, DRAM, or SDRAM, as examples. Computer system 500 includes ROM 504 which may be PROM, EPROM, or EEPROM, as examples. RAM 503 and ROM 504 may hold user and system data and programs as is well known in the art.

Computer system 500 also includes input/output (I/O) adapter 505, communications adapter 511, user interface 508, and display adapter 509. I/O adapter 505 connects to storage devices 506, such as one or more of hard drive, CD drive, floppy disk drive, tape drive, to computer system 500. In accordance with embodiments of the present invention, audit data may be written to a file or files on any one of storage devices 506. Communications adapter 511 is adapted to couple computer system 500 to a network 512, which may be one or more of telephone network, local (LAN) and/or wide-area (WAN) network, Ethernet network, and/or Internet network. User interface 508 couples user input devices, such as keyboard 513 and pointing device 507, to computer system 500. Display adapter 509 is driven by CPU 501 to control the display on display device 510.

Computer system 500 advantageously employs a series of start-up operations to initialize the system. Computer system 500 may access configuration files on one of storage devices 506 to load portions of the operating system. When initializing the operating system, computer system 500 loads the kernel into RAM 503. Computer system 500 further creates the syscall table to provide the offset addresses to the routines of the kernel. After normal start-up procedures have been completed, computer system 500 executes a configuration program according to embodiments of the present invention. The configuration program copies the original syscall table to a new memory location in RAM 503. The configuration program loads the wrapper functions which perform the desired audit tasks into RAM 503. The configuration program then rewrites the syscall table so that system calls originated by user space applications are first directed to the wrapper functions.

Embodiments of the present invention provide several advantages over prior art auditing systems. In particular, audit code may be dynamically added, removed, or updated without rebuilding the kernel system call routines. Specifically, the wrapper functions separate the audit code from the kernel system call code. When it is desired to change the audit code, the changes are made in source code in a manner that is well known in the art. The source code with the desired changes is compiled into a processor executable form. The processor executable code is then installed on the particular system to execute the desired changes. Since the audit code and the kernel system call code is separate, changes to the audit code do not require the kernel system call routines to be rebuilt. For similar reasons, changing the kernel system call code does not require modification of the audit code. Specifically, new versions of an operating system do not require porting the audit code.

Additionally, embodiments of the present invention are capable of eliminating extraneous audit data that is unnecessary for a particular system. For example, when an audit data is determined to be unnecessary, audit data may be eliminated by utilizing specialized code in selected wrapper functions to filter audit data as necessary. The specialized code may perform logical comparisons of various arguments to predefined criteria to determine whether auditing is appropriate. For example, the audit code may examine the filename and pathname associated with a particular file open operation. If the filename and pathname refer to system resources that possess little security concerns, the audit code may forgo generating audit data. Alternatively, certain wrapper functions may be completely disabled without effecting the operations of the kernel. Specifically, certain wrapper functions may be selectively disabled by rewriting the memory addresses of the respective kernel system call routines into the syscall table.

What is claimed is:

1. A computer readable medium including instructions executable by a processor-based system, said computer readable medium comprising:
code for replacing address information in a system call table with address information associated with a plurality of wrapper functions; and
code for defining said plurality of wrapper functions, said plurality of wrappers functions transferring processing control to system call routines, said plurality of wrapper functions retrieving parameters associated with said system call routines, said plurality of wrapper functions utilizing said parameters to generate audit data, and said plurality of wrapper functions writing said audit data to a buffer.

2. The computer readable medium of claim 1 further comprising:
code for copying said system call table to a new memory location as an original system call table copy before replacing said system call table with address information associated with said plurality of wrapper functions.

3. The computer readable medium of claim 2 wherein at least one of said plurality of wrapper functions is operable to examine memory information of said original system call table copy and is operable to transfer control to a system call routine associated with said memory information.

4. The computer readable medium of claim 1 further comprising:
code for examining an amount of audit data in said buffer; and
code for writing said audit data to an audit file when the amount of audit data in said buffer exceeds a predetermined amount.

5. The computer readable medium of claim 1 wherein at least one of said plurality of wrapper functions comprises code for performing a logical comparison of said parameters against predefined criteria to determine whether to write audit data to said buffer.

6. A method for generating audit data comprising the steps of:
placing a wrapper function in memory;
writing address information into an entry of a system call table, said address information being associated with said wrapper function; and
transferring processing control to said wrapper function, said wrapper function transferring processing control to a system call routine, retrieving parameters associated with said system call routine, utilizing said parameters to generate audit data, and writing said audit data to a buffer.

7. The method of claim 6 wherein said entry is associated with a vector, said method further comprising the step of:
generating a system call utilizing said vector.

8. The method of claim 6 further comprising the steps of:
copying an original entry in said system call table associated with said vector to a new location.

9. The method of claim 8 further comprising the steps of:
accessing said copy of an original entry to obtain memory information related to said system call routine; and
transferring processing control to said system call routine.

10. The method of claim 6 wherein said step of transferring processing control includes generating a software interrupt.

11. The method of claim 6 further comprising the step of:
disabling said wrapper function by restoring original address information to said entry of said system call table.

12. The method of claim 6 wherein said wrapper function performs a logical comparison between said parameters and predefined criteria to determine whether to write audit data to said buffer.

13. The method of claim 6 further comprising the steps of:
examining the amount of audit data in said buffer; and
writing said audit data to an audit file, when said amount of audit data exceeds a predetermined amount.

14. A computer system for generating audit data associated with system calls, said computer system comprising:
means for receiving processing control, said means for receiving being operable to transfer processing control to a system call routine and being operable to generate audit data associated with said system call routine; and
means for transferring control to said means for receiving, wherein said means for transferring control includes a system call table with address information associated with said means for receiving processing control.

15. The computer system of claim 14 further comprising:
means for creating a copy of an original system call table, and wherein said means for receiving processing control is operable to determine the memory location of said kernel system call routine by accessing said copy of said original system call table.

16. The computer system of claim 14 wherein said means for receiving processing control includes means for writing audit data to an audit buffer.

17. The computer system of claim 16 further comprising:
means for monitoring an amount of audit data in said audit buffer; and
means for writing buffered audit data to an audit file when said amount of audit data exceeds a predetermined amount.
